(19) United States
(12) Patent Application Publication
(10) Pub. No.: US 2016/0155366 A1
(43) Pub. Date: Jun. 2, 2016

(54) DISPOSABLE WRISTBAND

(71) Applicant: OSUNG SYSTEM CO., LTD., Seoul (KR)

(72) Inventor: Tae-Seung SHIN, Bucheon-si, Gyeonggi-do (KR)

(73) Assignee: OSUNG SYSTEM CO., LTD., Seoul (KR)

(21) Appl. No.: 14/787,360

(22) PCT Filed: Jun. 30, 2014
(86) PCT No.: PCT/KR2014/005819

§ 371 Date: Oct. 27, 2015

(30) Foreign Application Priority Data
Jul. 17, 2013 (KR) 10-2013-0084065
Apr. 22, 2014 (KR) 10-2014-0047808

(51) Int. Cl. G09F 3/00

(52) U.S. Cl. CPC G09F 3/005

(57) ABSTRACT

A disposable wristband comprises: a base thin film formed of a fabric material having a strip shape to be worn on a user' s wrist; a first coating layer coated on an upper surface of the base thin film; a second coating layer coated on a lower surface of the base thin film; and adhesive tape attached to the first coating layer or the second coating layer and disposed at an end in a longitudinal direction of the base thin film to wrap and fix the base thin film on the wrist.

### BACKGROUND

The present invention relates to a disposable wristband worn on a user's wrist, and more particularly, to a disposable wristband on which various kinds of information such as a wearer's unique identification information are written.

### BACKGROUND ART

In general, in medical facilities such as hospitals and clinics, a wristband for patient management showing patient management information including a patient' s name, age, sex, blood type, hospital ward, and so on, is used to manage the patient.

Further, in recent times, even in theaters for various plays or concerts, large buffets, conference halls, and so on, wristbands are provided to visitors to provide various kinds of information including seat positions, admission, or the like.

Meanwhile, various types of disposable wristbands are disclosed in Korean Utility Model Publication No. 1998-016229, entitled “Wristband Having Memo Paper Insertion Section,” Korean Patent Publication No. 2013-0083448, entitled “Wristband, Wristband Continuum and Method of Wrapping Wristband,” and so on.

For example, as shown in FIG. 1(a), the disposable wristband includes a base film 11, an adhesive layer 12 and a display film 13 such that the base film 11 is can be cut along a cutting line C to expose the adhesive layer 12 and to be worn on a user's wrist.

In addition, as shown in FIG. 1(b), the display film 13 includes a handwriting box 13a and an advertisement section 13b, and a manager can directly write a wearer's identification information on the handwriting box 13a, or adhere or insert a sticker on which identification information is printed.

However, most disposable wristbands of the related arts use coated paper as the base film 11 or the display film 13. Accordingly, the wearer's wrist may be cut by a sharp edge of the paper.

In addition, when the wristband is formed of vinyl or a synthetic resin having tear resistance and wetting resistance, the wristband may cause various skin problems such as an allergy in a person who has sensitive skin or a child when the wristband is worn for a long time.

For this reason, synthetic leather may be used instead of the base film 11 or the display film 13 and a dot button may be used as a detachment means. However, in this case, manufacturing cost is increased and the wrist is pressed by the dot button, making wear uncomfortable.

In addition, due to properties of the material of the related art, the wearer' s identification information cannot be easily printed on the display film 13 using a printer. Even when the printing is performed, since the printing is easily smudged or wiped off, a manager should directly write the information on the wristband.

### SUMMARY OF INVENTION

In order to solve the above-mentioned problems, an object of the present invention is directed to provide a disposable wristband capable of enabling printing by manufacturing the wristband using a fabric material, nylon cloth, preventing a wearer' s skin from being cut, providing comfortable wear, and preventing skin problems such as allergies.

In order to achieve the aforementioned objects, a disposable wristband according to the present invention includes a base thin film formed of a fabric material having a strip shape to be worn on a user' s wrist; a first coating layer coated on an upper surface of the base thin film; a second coating layer coated on a lower surface of the base thin film; and adhesive tape attached to the first coating layer or the second coating layer and disposed at an end in a longitudinal direction of the base thin film to wrap and fix the base thin film on the wrist.

Here, the base thin film may be formed of nylon cloth.

In addition, the first coating layer and the second coating layer may be layers coated on the base thin film by dip-coating polyamide on upper and lower surfaces of the base thin film.

In addition, the adhesive tape may be double-sided tape, and a release paper may be attached to an outer surface of the double-sided tape.

In addition, an identification information box on which information is printed by a printer may be formed at one side of the base thin film.

The present invention uses the fabric material as the base thin film that constitutes the disposable wristband. In particular, among fabric materials, the nylon cloth is used.

Accordingly, the disposable wristband has a good printing property such that various kinds of information can be printed by a printer, has comfortable wear, prevents a wearer's wrist from being cut, and prevents skin problems from occurring.

In addition, coating layers configured to protect the upper and lower surfaces of the base thin film are coated with polyamide through dip coating.

Accordingly, printing properties, comfort in wear, and so on, are further improved, and occurrence of an allergic reaction is prevented.

### BRIEF DESCRIPTION OF DRAWINGS

FIG. 1 is a view showing a disposable wristband according to the related art.

FIG. 2 is an exploded view showing a disposable wristband according to the present invention.

FIG. 3a is a view showing a first use example of the disposable wristband according to the present invention.

FIG. 3b is a view showing a second use example of the disposable wristband according to the present invention.

FIG. 4 is a view showing an example of a method of manufacturing a disposable wristband according to the present invention.

FIG. 5 is a view showing an example of a method of printing a disposable wristband according to the present invention.

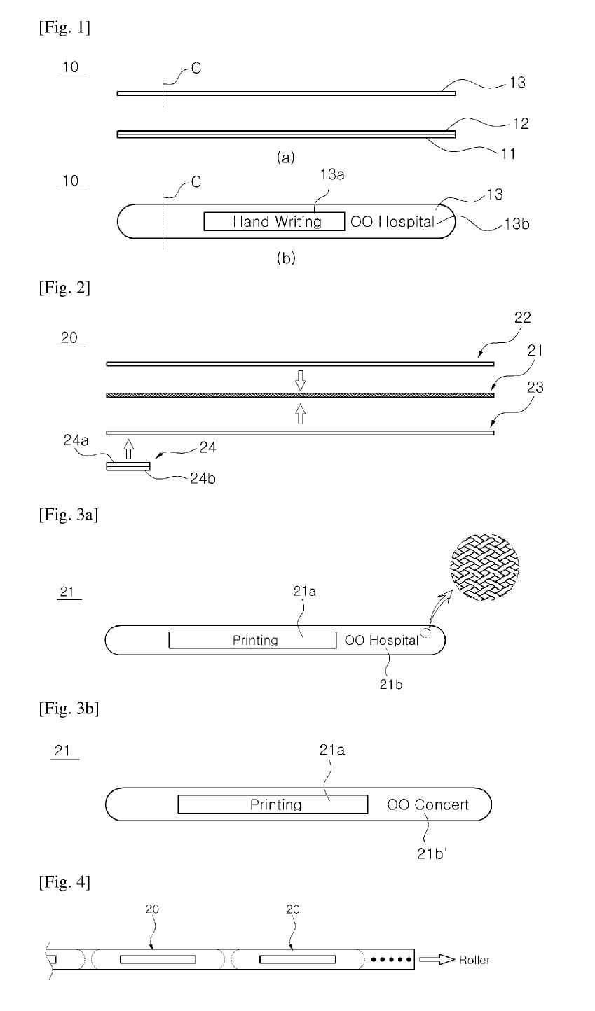

### DETAILED DESCRIPTION OF EMBODIMENTS

Hereinafter, a disposable wristband according to an exemplary embodiment of the present invention will be described with reference to the accompanying drawings.

As shown in FIG. 2, a disposable wristband 20 according to the present invention includes a base thin film 21, a first coating layer 22, a second coating layer 23 and adhesive tape 24.

Here, the first coating layer 22 is coated on an upper surface of the base thin film 21, and the second coating layer 23 is coated on a lower surface of the base thin film 21.

The adhesive tape 24 is attached to the first coating layer 22 or the second coating layer 23. However, when the upper surface of the base thin film 21 is a printing surface, the adhesive tape 24 may be attached to the second coating layer 23 opposite thereto.

Meanwhile, in the above-mentioned configuration, the base thin film 21 is formed of a fabric material. In addition, the wristband has a strip shape to be worn on a user's wrist.

A usable fabric material should first be able to be printed on, second, it should be comfortable to wear and a wearer's wrist should not be cut by a sharp edge, third, it should be harmless to the human body such that those with sensitive skin can wear the wristband, and fourth, it should have excellent durability and moisture tolerance.

The present invention uses nylon cloth as a fabric material that satisfies the above-mentioned conditions. Nylon cloth is a ‘cloth’ formed of nylon fibers, and the word ‘cloth’ as used herein refers to a fabric. Nylon is a general term for a synthetic polymer polyamide that is connected by an amide bond —CONH— and is a chain-shaped polymer.

In particular, unlike typical fibers, nylon cloth has a very good printing property. Accordingly, as shown in FIGS. 3a and 3b, not only a wearer' s information but also additional information can be printed and used using a printer or the like.

For example, as shown in FIG. 3a, the disposable wristband is used as a wristband for a patient when the wristband is used in a hospital. Here, a patient' s name, age, sex, blood type, hospital ward, and so on are printed in an identification information box 21a.

A hospital name, a hospital telephone number, an advertisement for the hospital or subcontractors (including a public advertisement), and so on are printed on an additional information box 21b separate from the identification information box 21a, and the various types of information mentioned above may be printed with a barcode.

While a base color of the identification information box 21a is preferably white, the additional information box 21b may be printed in various base colors according to characteristics of a place at which the wristband is used. When the place is a hospital, a color that symbolizes the hospital may be used as a base color.

As another example, as shown in FIG. 3b, when the disposable wristband is used at a concert, a concert date, a designated seat number, and so on, are printed in the identification information box 21a, and a concert subject, an agency name and various advertisements are printed in an additional information box 21b′ separate from the identification information box 21a.

In addition, nylon cloth is harmless to the human body, and the following table shows results regarding heavy metal content of nylon cloth obtained by the FITI Testing and Research Institute in Korea. Samples were extracted with artificial acidic sweat according to an ISO 105 E04 method at 37° C. for four hours, and heavy metal content was measured using ICP-AES and UV/VIS Spectrophotometry.

TABLE 1

| Heavy metal element | Heavy metal content (mg/kg) |
|---|---|
| Lead (Pb) | Less than 0.1 |
| Arsenic (As) | Less than 0.1 |
| Chromium (Cr total) | Less than 0.1 |
| Chromium VI | Less than 0.1 |
| Cobalt (Co) | Less than 0.1 |
| Nickel (Ni) | Less than 0.1 |
| Mercury (Hg) | Less than 0.01 |
| Copper (Cu) | Less than 0.1 |
| Cadmium (Cd) | Less than 0.1 |

As shown in Table 1, it will be appreciated that nylon cloth has an extremely small heavy metal content in various indices that shows harmlessness to the human body. Of course, while other indices were also tested and showed harmlessness to the human body, the test results thereof will be omitted.

In addition, nylon cloth is constituted by a dense fiber tissue as shown in a partially exploded view of FIG. 3a, and has good durability preventing easy tearing and good moisture tolerance preventing it from being easily wet with water or sweat.

Of course, since nylon cloth is formed of dense fiber tissues, printing with photograph clarity can be performed as described above, and printed characters or figures can be prevented from being smudged or wiped off.

Next, the first coating layer 22 and the second coating layer 23 are provided to protect the base thin film 21, the first coating layer 22 is coated on an upper surface of the base thin film 21, and the second coating layer 23 is coated on a lower surface of the base thin film 21.

Here, each of the first coating layer 22 and the second coating layer 23 is formed of 100% polyamide, and is formed by dip-coating polyamide on the upper and lower surfaces of the base thin film 21.

Dip coating refers to a method of dipping a coating target material in a coating solution of slurry to form a precursor layer on a surface of the coating target material and plasticizing the precursor layer to obtain a film, and may also be referred to as an immersion coating method.

In particular, as is well known, polyamide has a good printing property, does not cause an allergic reaction, and has a light weight and very soft texture. Accordingly, in the present invention, the first coating layer 22 and the second coating layer 23 formed of a polyamide material are selected and the polyamide material is used as a coating material of the base thin film 21.

Next, the adhesive tape 24 used to wrap the disposable wristband of the present invention on the wearer's wrist and fix it is attached to the first coating layer 22 or the second coating layer 23. However, since the upper surface of the base thin film 21 is a printing surface, the adhesive tape 24 is preferably attached to the second coating layer 23 opposite thereto.

In addition, the adhesive tape 24 is locally attached to an end side in a longitudinal direction of the base thin film 21. Accordingly, a user wraps the base thin film 21 on his/her wrist and crosses a portion of the base thin film 21 to which the adhesive tape 24 is attached to couple the wristband on the wrist.

FIG. 2 shows double-sided tape as an example of the adhesive tape 24. The double-sided tape includes adhesive paper 24a on both surfaces of which an adhesive material is applied, and release paper 24b attached to a bottom surface of the adhesive paper 24a. Accordingly, the wrist band can be instantly put on by removing the release paper 24b.

Hereinafter, a method of manufacturing a disposable wristband of the present invention constituted by the above-mentioned configuration and a method of inserting the disposable wristband into a printer to output various kinds of information will be described.

First, a fabric of the base thin film 21 formed of the nylon cloth is prepared to manufacture a disposable wristband of the present invention. The fabric is long enough to manufacture a plurality of disposable wristbands simultaneously.

Next, a plurality of identification information boxes 21a and a plurality of additional information boxes 21b are continuously printed on the prepared fabric of the base thin film 21. Here, the identification information box 21a remains blank, and a base color, a use place, an advertisement phrase, a telephone number, and so on are printed in the additional information box 21b.

The printing may be offset printing, rotary press printing, gravure printing, master printing, hot stamping printing, screen printing, pad printing, UV printing, digital printing, decal comania, and so on.

A dense fabric material is used as the base thin film 21 in the present invention. In particular, the nylon cloth having a very good printing property is used. Accordingly, various printing methods can be used without particular limitation, and the printing quality is excellent.

Next, the first coating layer 22 and the second coating layer 23 formed of the polyamide material are dip-coated on the upper and lower surfaces of the fabric of the printed base thin film 21, and the fabric of the base thin film 21 on which the first coating layer 22 and the second coating layer 23 are coated is dried and cured for a certain time.

Next, when the curing is terminated as shown in FIG. 4, a perforated line is formed according to a size and a shape of an individual disposable wristband, and the wristband having the perforated line is wrapped on a winding roller to be provided as a final product.

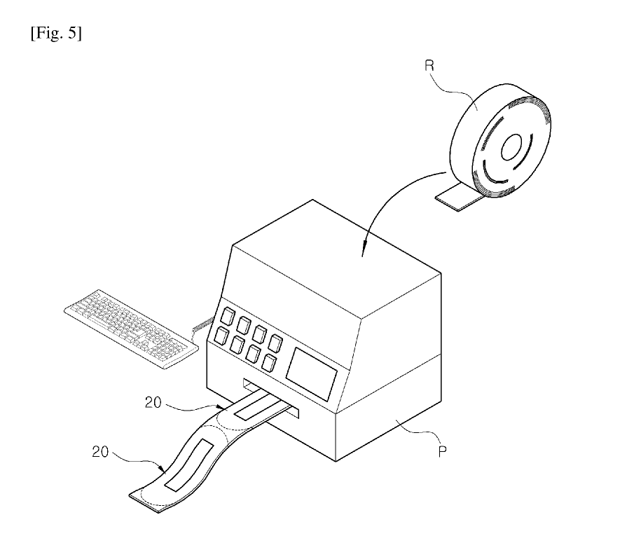

Next, as shown in FIG. 5, a winding roller R is mounted on a special printer P to provide disposable wristbands, and the special printer P prints a wearer's identification information on the identification information box 21a of the disposable wristband. Since the wearer's identification information is not previously determined, the wearer's identification information is printed in a final step.

Here, the wearer's identification information may be input through a keyboard or the like, and the wristband printed by the special printer P is output. Accordingly, a manager cuts the wristband along the perforated line to provide the cut wristband to a wearer, and the wearer removes the release paper 24b of the adhesive tape 24 to put the wristband on.

Hereinabove, a specific embodiment of the present invention has been described in detail. However, it will be apparent to those skilled in the art that the spirit and scope of the present invention are not limited to the specific embodiment but various modifications and changes may be made without departing from the scope of the present invention.

Accordingly, since the above-mentioned embodiment of the present invention is provided to completely inform those skilled in the art of the scope of the present invention, the embodiment should be understood as being exemplary rather than restrictive in all aspects, and the present invention will be defined only by the following claims.

1. A disposable wristband comprising:
a base thin film (21) formed of a fabric material having a strip shape to be worn on a user's wrist;
a first coating layer (22) coated on an upper surface of the base thin film (21);
a second coating layer (23) coated on a lower surface of the base thin film (21); and
adhesive tape (24) attached to the first coating layer (22) or the second coating layer (23) and disposed at an end in a longitudinal direction of the base thin film (21) to wrap and fix the base thin film (21) on the wrist.

2. The disposable wristband according to claim 1, wherein the base thin film (21) is formed of nylon cloth.

3. The disposable wristband according to claim 2, wherein the first coating layer (22) and the second coating layer (23) are layers coated on the base thin film (21) by dip-coating polyamide on upper and lower surfaces of the base thin film (21).

4. The disposable wristband according to claim 3, wherein the adhesive tape (24) is double-sided tape, and a release paper (24b) is attached to an outer surface of the double-sided tape.

5. The disposable wristband according to claim 1, wherein an identification information box (21a) on which information is printed by a printer is formed at one side of the base thin film (21).
